(19) United States
(12) Patent Application Publication
(10) Pub. No.: US 2026/0162102 A1
(43) Pub. Date: Jun. 11, 2026

(54) INTEGRATED PROGRAMMABLE TOKEN DEVICE AND LIVE VIDEO et al.

(71) Applicant: Ayo Omoniyi Ilesemi, Lagos (NG)

(72) Inventor: Ayo Omoniyi Ilesemi, Lagos (NG)

(21) Appl. No.: 18/698,785

(22) PCT Filed: Oct. 5, 2021
(86) PCT No.: PCT/IB2021/059103

§ 371 Date: Apr. 5, 2024

(51) Int. Cl. G06Q 20/36; G06Q 20/06

(52) U.S. Cl. CPC G06Q 20/3674; G06Q 20/065

(57) ABSTRACT

This inventive work relates more particularly, to the development of a device to drive live monetization, live payment and live donations for the entertainment, fundraising and other kind of live events therefore providing the event industry a means for monetizing and paying for live events services and contents. The invention is also creating a tailored live video streaming production method with a new live feedback set-up especially for the live event industry therefore aiding event owners or contents producers and their distant audiences with a more effective means for converging, transacting business and interacting more remotely, and particularly, helping the industry in achieving uninterrupted dealings even in times of lockdown due to epidemic, pandemic or any other security measures restricting people from movement.

The present invention relates to a device, preferably but not necessarily exclusively for digitalization of an act of money spraying to drive live monetization and live payments for live and online entertainment and event services and contents. The invention further relates to a method of operating said device, as well as to a method of live video streaming providing magnified live feedback. A system for enabling said method is also provided within the scope of the present invention.

Online has becoming the new ecosystem and space for living due to coronavirus and this disruption has made us to see that existing live video streaming platforms run best as spaces for hooking up with ourselves for discussions and viewing. Perhaps they were all modelled for just creating digital clusters to drive advertisement needs of brands, that is why advertisement still remains the main means of revenue generation for most of the existing platforms. Therefore, the best way they could serve the entertainment and other live event industry presently is broadcasting it, because they lack some technology, applications or features necessary to drive typical entertainment-event business live transactions.

It is serious how the monetization (subscription & ads insertion) models of existing platforms failed to serve the live event industry in monetizing their contents during the pandemic restrictions and how no existing platforms could readily help entertainers and many users who were restricted from holding public live shows to monetize their content remotely even though they could continue to produce live contents right from their homes but with no readily available means of monetizing their works. Therefore, many artists manually placed their bank details on the screen of existing platforms at the kindness or mercy of consumers consuming their content without having control over such consumption and monetization of their services. This could mean loss of income and business to any entertainers and anyone using those platforms and which really resulted to income losses to lot of people during the heat of the COVID-19.

Likewise Artistic online-performance is not new—but until now, the practice has not been a significant alternative to replicate many senses of “liveness” and interactions as found during live party events. Fans interaction is a vital part of artistic performances if one wants to keep people interested and coming back. The more ways you can get fans involved in the show, the happier they will be. With advancements in technology, online fans desire for artist interaction is on the increase.

Perhaps the most common and easy means of live-online-interaction is live streaming video captured by an Artist who just feel to share any live content using the front camera of a smartphone and at such moment can simultaneously respond to connected viewer's comments on the content during the streaming, Unfortunately, with existing live video production methods for a serious and high quality live video streaming production such as for concerts, artists are set-up to be fully engrossed in the production processes and therefore left with no provision to interact live with any online fans connected to them while they are on stage but can only communicate back or attend to comments dropped by fans anytime after the live streaming production.

The present invention seeks to provide a means of facilitating and improving the live-online interaction, and replicate live vibes for all participants.

According to a first aspect of the invention, there is provided a device for digitalization of an act of money spraying to drive live monetization and live payments for live and online entertainment and event services and contents, comprising: a transaction trigger input; a display screen configured to display a transactional value to be authorised by the user during an act of money spraying; a memory storage element for storing at least a currency type and currency amount which contribute to the said transactional value; a wireless communications means communicable with third-party devices; a user identification authorisation mechanism configured to generate a one-time passcode for an e-wallet associated with the device; and a processor configured to validate a transfer of the said transactional value from the e-wallet to a third-party upon activation of the transaction trigger input.

The provision of a single device for performing pre-programmed money spraying actions, whilst also providing user security via a one-time passcode, ensures that money-spraying can be performed at a live event, or remote thereto, whilst creating live vibes which can be easily displayed to the content producer. For instance, an ideogram could be provided which expresses or animates the concept of money-spraying, and which can be displayed to the consumers and/or content producer. Whilst a transaction during money spraying will occur from a user's e-wallet to a content provider's e-wallet preferably via a live video streaming application, the present device allows for remote validation of the transaction to simplify the action for the user in a safe and secure manner.

The device may preferably further comprise at least one of a currency selection button and a denomination selection button for selecting pre-loaded data of currencies and/or denominations stored in the memory storage element.

The use of specific buttons for currency and/or denomination change allow the device to be used in a wide variety of different countries and contexts.

The device may further comprise a switch for selectable activation or deactivation of the wireless communications means.

It is preferred that the device be configured to allow users to display, in an ostentatious fashion, their money-spraying activity to public screens in the live venue, for instance, to receive a shout-out from the content producer. However, the user may prefer to maintain their privacy, and this can be achieved by deactivating the wireless communication means of the device. This may be a switch which only deactivates one specific type of wireless communications means, such as WiFi®, in order to prevent communications with external public display screens without inhibiting other means of communication, for instance, communication via near-field communication such as Bluetooth® to a user's smartphone.

Preferably, the memory storage element may comprise stored instruction having any or all of the following functions; selecting and displaying currency denominations; displaying the one-time passcode; remotely accessing an e-wallet in a digital payment-solution-enabled-live-video-streaming application running on a separate and disconnected device; driving remote validation and activation of a final and concluding instruction of transferring a pre-set amount of money from the accessed e-wallet; and/or driving a user identification-authentication protocol to create a login security for a user.

It is preferred that a wide range of functionality be provided for the device, which allows for not only secure transactions to be performed, but also different payment options to be completed.

The device optionally further comprises a remote instruction-activation mechanism which is configured to allow the device to remotely and wirelessly locate and connect to another device on which a digital payment-solution-enabled-live-video-streaming application is running, and further configured to remotely validate and activate a final and concluding instruction of money transfer from the e-wallet in the digital payment-solution-enabled-live-video-streaming application running on the located and connected device.

The connectivity functionality allows the device to find the user's e-wallet, to rapidly enable correct transactions to occur during a money-spraying event, without needing to enter large amounts of validation information. The user may then use their smartphone or similar mobile computer to ensure that the transaction connects to the correct content producer e-wallet, for example, via the use of a dedicated software application which facilitates this process for the user.

Preferably, the device may be configured to turn on either at the press of the transaction trigger input for the first time of use, or when a wireless connection of the device on which an e-wallet supported live video streaming application is installed is switched on.

Different functional options for the activation of the device may improve the ease with which it can be used, enabling different functional actions to perform different functional tasks.

Optionally, the device may be configured to turn off automatically when it is left unused or inoperative for a predetermined duration.

Automatic shut-off of the device during an inactive period may further improve the security of the device.

The processor may be configured to activate random transfer (spraying) of money via random pressing of the transaction trigger input. The processor may further be configured to activate money transfer only if authorisation data on the display screen is the same as authorisation data in a user's e-wallets account.

The processor may be adapted to provide many different functionalities which improve the quality of the impress device.

Optionally, the display screen may be configured to selectably switch between displaying a currency and/or denomination activatable by the transaction trigger input and the one-time passcode, depending on a mode of use.

Switching between the displays may remove the need to provide multiple display screens on the device, reducing the cost of manufacture thereon.

Preferably, the wireless communications means may comprise a WIFI® communications means.

Wireless internet is one of the most common and easiest communications protocols to use to interconnect the device with other external devices. Other communications protocols will, of course, be viable, such as barcode or Bluetooth® communication protocols.

Optionally, the wireless communication means may comprise a communication protocol for communicating with an external display screen for the purpose of enabling the user to create an ostentatious vibe for public viewing.

According to a second aspect of the invention, there is provided a method of operating the device in accordance with the first aspect of the invention as an integrated money transfer device, the method comprising the steps of: a] accessing a live video streaming application associated with the device using an external user device; b] linking the device to an e-wallet service of the live video streaming platform; c] activating the device for dual-use by using the user identification authorisation mechanism to generate a one-time passcode that can be used to log into the user's e-wallet account; and d] using the transaction trigger input to initiate and/or validate a payment order from the user's e-wallet account to the e-wallet service of the live video streaming platform.

The present invention allows a user to connect the device with a live video streaming application using, for example, their smartphone, with the live video streaming application being e-wallet enabled. Provided the user owns both the external device and the impress device, there is a secure link maintained therebetween, and no additional third party device is required. From there, the user can use the impress device as a means of performing a money spraying action simply and safely.

According to a third aspect of the invention, there is provided a method of live video streaming providing magnified live feedback, the method comprising the steps of: a] channeling live video and audio files through an e-wallet-supported live video streaming application; b] broadcasting the live video and audio captured as a live media stream to online consumers; and c] duplicating the live media stream enriched with live reactions/interactions from live and/or online consumers and sending it back to an on-stage content producer through a display screen; wherein the live video streaming application is programmed to process the live video and audio captured via an encoding and transcoding software program to create and convert animation of an act of money spraying to real money transfer within e-wallets operated within the tailored e-wallet supported live video streaming application.

During step c], the display screen is a modular display screen comprising a plurality of individual modules which are interconnected.

Such a modular display screen allows a large screen to be disassembled and readily transported.

Optionally, the live reactions/interactions may comprise audio reactions from live and/or online consumers.

During step c], all money transfer (spraying reactions) from the content consumers may be fed back live to contents producer while on stage.

According to a fourth aspect of the invention, there is provided a system for enabling live video streaming providing magnified live feedback, the system comprising: a] audio-visual broadcasting equipment for recording and streaming a live event to a remote audience; b] an on-stage display screen configured to display a live broadcast from the audio-visual broadcasting equipment to a content producer on the stage; and c] feedback equipment to relay to the on-stage display screen live feedback information from the remote and/or a live audience direct to the content producer.

The system may further comprise at least one device in accordance with the first aspect of the invention, wherein the live feedback information comprises data relating to a money-spraying action performed to the content producer.

The system may further comprise at least one public display screen for displaying the live feedback information to the said live audience.

The on-stage display screen may be a modular display screen comprising a plurality of individual modules which are interconnected.

According to a fifth aspect of the invention, there is provided a modular display screen for use with a system preferably in accordance with the fourth aspect of the invention, the display screen comprising a plurality of individual modules which are interconnected to form a larger unified display screen, wherein each of the individual modules includes a rigid connection region via which the display screen can be assemble in a frameless or framed manner.

A modularly disassembleable display screen can be transported in the boot of a standard car or in a van, without requiring specialist transportation means. A larger display screen can thus be constructed to size on site.

The display screen optionally may comprise a modularly assembleable frame around the plurality of individual sub-screens. Preferably, the modularly assembleable frame may comprise a plurality of interconnectable frame members.

Preferably, the plurality of individual sub-screens may be interconnected via one or more fastening elements.

With this tailored invention, a perfect blend of control, support, flexibility and fun is made readily available now to drive live donations at fundraising programmes therefore bringing more transparency of charity projects and to drive live payment and live monetization of any entertainment-events contents and services.

This invention develops a possibility for artists who are present on-the-stage to be able to engage in a more and deeper interactions such as replicating live vibes with both live and online fans.

In order to establish the market values of this new means of live monetization for live event services and contents and as well as a means of conveying people's inherent feelings for more interaction during any live and online shows, the subject-matters discussed below will further establish the scope of the present invention.

The focus of these inventive works is on creating sustainable and alternative ways of monetizing live entertainment and events and such ways that can also fully convey live vibes or liveness peculiar to live events. In other words, this invention is creating more ways to interface artists and their fans/clients for closer and enhanced live interaction and ways for monetizing and paying for contents and services during any live online performances.

According to the invention, there is provided a device for digitalization of an act of money spraying to drive live monetization and live payments for live and online entertainment and event services and contents, comprising: a processor configured to execute the following computer executable components; a remote instruction-activation mechanism; a user identification-authentication mechanism; an OK/Power keypad; an LCD display screen; a device switch; a WiFi® switch; a currency selection button; a denomination selection button; and a memory thereon storing a minimal computer executable instructions.

The processor may interpret data with the help of the minimal computer executable instructions stored on the memory, wherein the stored instructions on the memory are highly specific in following functions; selecting and displaying denominations of currencies of countries; displaying one-time passcode; remotely accessing an e-wallet in a digital payment-solution-enabled-live-video-streaming application running on a separate and disconnected device; driving remote validation and activation of a final and concluding instruction of transferring a pre-set amount of money from the accessed e-wallet; and/or driving a user identification-authentication protocols to create a login security for a user.

Data may be transmitted between the processor and all of its integrated components using intra communication protocols but data are transmitted with disconnected or separated devices-such as a smartphone, tablet, laptop and television via built-in remote access protocols.

The remote instruction-activation mechanism may be configured to allow the device to remotely and wirelessly locate and connect to another device on which the digital payment-solution-enabled-live-video-streaming application is running, and further configured to remotely validate and activate a final and concluding instruction of money transfer from the e-wallet in the digital payment-solution-enabled-live-video-streaming application running on the located and connected device.

The device may be configured to turn ON either at the press of the OK keypad for the first time of use, or when a wireless connection of the device on which the e-wallet supported live video streaming application is installed is switched on. And turns OFF only when it is left unused or inoperative after a set time.

The OK keypad may be configured to activate random transfer (spraying) of money via random pressing of the OK keypad.

The OK keypad may be further configured to activate money transfer only if the pre-set instructions on the device's LCD screen is the same as the pre-set instructions in a user's e-wallets account.

The LCD screen may be configured to display denominations and currencies of different countries providing display of a denomination of a particular currency one at a time when the device is deployed as a live payment/money spraying device. The LCD screen may be further configured to display One-Time Passcode when it is deployed as a user identification-authentication device.

The device switch may be configured to allow the device to serve dual purposes of being deployed either as a digital payment/money spraying device or as a user's identification-authentication device per time.

The WiFi® connection switch may be configured to switch ON/OFF the WiFi® providing connection of the device a larger display screen for the purpose of creating larger views of its operations and also enabling the user to create ostentatious vibe for public viewing.

The denomination and currency selection buttons may be configured respectively for selecting pre-loaded data of denominations of countries stored in memory of the device.

According to the present invention, there is provided a process of working the device herebefore described as an integrated money transfer device, comprising: accessing a secure e-wallet service driven conjointly with a live video streaming service to drive money transfer within e-wallets of a content producer and any content consumers streaming and consuming a content respectively and simultaneously via the e-wallet supported live video streaming platform, providing a means for a content producer to conjointly stream and monetize contents on a single platform and also a means for any consumers of the contents to pay for consuming the streaming contents, the process further comprises of; steps of linking the device to the e-wallet service of the live video streaming platform; the User of device of claim 1 enrolls for an e-wallet account from the conjoint live video streaming-digital payment services application and user is required to link the device to the enrolled e-wallet account by registering the device in the enrolled account; the live video streaming & digital payment services platform provider acknowledges the enrolment of the user and the linkage of the device to the account via SMS. To ensure secured transactions in using the device, each device is only linkable to one user's e-wallet account(s); user saves their primary bank account details and the e-wallet account information of any content producer whose contents they are consuming in their enrolled e-wallet account for the purpose secured transferring money into the content producer's e-wallet account in exchange for consuming their contents online and/or on-stage; and steps of activating the device for dual-use; user choose to activate the dual-use option of the device to create an extra security for logging into the user's e-wallet-live video streaming account by switching the device, to serve as user identification and authentication device through the push of the device switch at the side of the device, and by pressing the OK keypad a one-time passcode will be generated that can be used to log in to the user's e-wallet account; and steps of operating the device; after logging into the e-wallet, the user of device of claim 1 sets up a payment order in the e-wallet account, selects an amount of money or a denomination of a currency or a country, pre-set it and pre-set a content producer's e-wallet account whose content the user of the device is consuming; then the user of the device needs to select a duplicate of the amount of money or denomination of a currency or a country as pre-set on the e-wallet also on the device; until the LED display screen of the device displays the duplicate of what is pre-set in the user's e-wallet account then, the user of device can randomly and remotely activate the final transfer (spraying) of the pre-set amount of money in their e-wallet to the e-wallet of a pre-set content producer by randomly pressing the OK keypad of the device.

According to a further aspect of the invention, there is provided a method of live video streaming providing magnified live feedback comprising: channeling live video and audio files through the e-wallet supported live video streaming application, wherein the application is programmed to process the live video captured via a tailored encoding and transcoding software programs to create and convert animation of act of money spraying to real money transfer within e-wallets operated within the tailored e-wallet supported live video streaming application; creating a live feedback production line setup within the conventional production set up of a high quality live video streaming; duplicating live media stream enriched with live reactions/interactions from live and online consumers and sending it back to the content producer right there on-stage through a magnified expandable, detachable and movable display screen display screen; providing a means to interface a content producer and their distant audiences in live interactions through the magnified, expandable, detachable and movable display screen; enabling, an on-stage production quality control even from the engrossed entertainer and production crew where any viable professional suggestions accessed from online consumers can be applied to drive instant and live improvement/adjustment; and providing a means for any contents producers to monetize their contents/services and for any contents/services consumers to pay (spray) money in exchange for consuming the contents via accessing the application that act of money spraying.

Live feedback from all content consumers may be connected to a content online is provided via wireless and/or cable connections of the following devices; a smartphone/tablet/laptop/smart TV, a video controller processor, the mirroring technology enabled magnified expandable, detachable and movable display screen big enough that an any content producer engaged in a live production can briskly glance, read and grasp the contents on the display screen from a reasonable distance.

The wireless and/or cable connections may be done in a way that the audio reactions of each connected consumer can be captured separately and connected to an audio console for achieving clearer and controllable live voice reactions feedback.

The method of duplicating a live media stream may be enriched with live reactions from online consumers is achieved by mirroring a screen of a smartphone, laptop, tablet or TV on which the live media stream enriched with live reactions from online consumers is showing into the magnified expandable, detachable and movable display screen

The method of providing a means to interface a content producer and their distant audiences in live interactions may be achieved by positioning the mirroring technology enabled magnified expandable, detachable and movable display screen in a strategic position on or near the production stage, ensuring the production is not disturbed such that any entertainer engaged in a live production can briskly glance and grasp reactions from any content consumers connected online and the entertainer in return reacts to the reactions;

The method of providing a means for contents producers to monetize their contents and a means for contents consumers to transfer money in exchange for consuming any contents may be achieved by broadcasting video contents through a wallet-based-payment-driven-live-video-streaming application where all money transfer (spraying reactions) from the contents consumers are fed back live to contents producer while on stage.

The mirroring technology enabled display screen may be configured to be detachable to smaller units sizes that can enter into a booth of any car for easy transportation and logistics and can be assemblable back, further configured to be expandable wherein two or more units of the display screen can be joined together to form a bigger one and also further configured to be movable wherein the display screen can be freely moved and placed around any suitable position with ease.

The invention will now be more particularly described, by way of example only, with reference to the accompanying drawings, in which:

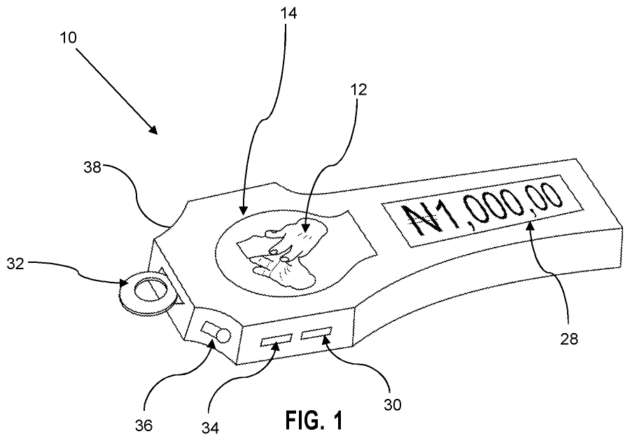

FIG. 1 shows a perspective representation of one embodiment of a device in accordance with the first aspect of the invention;

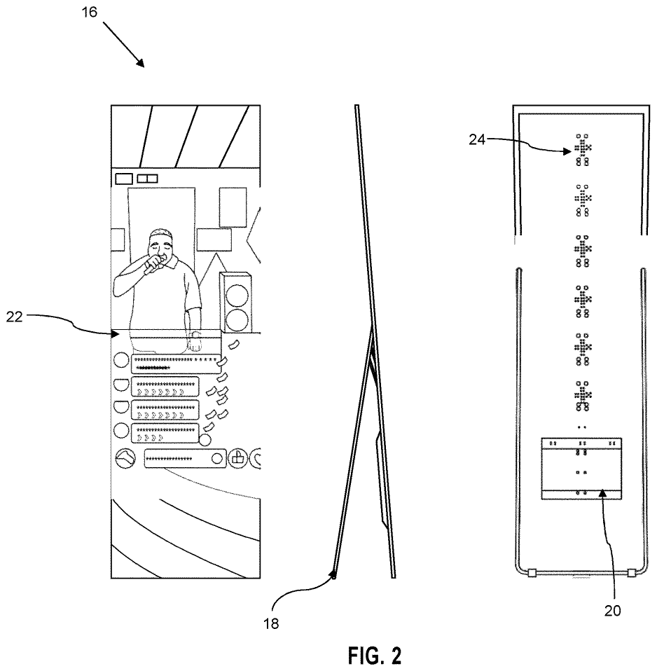

FIG. 2 shows representations of one embodiment of a live feedback display screen used in accordance with the present invention;

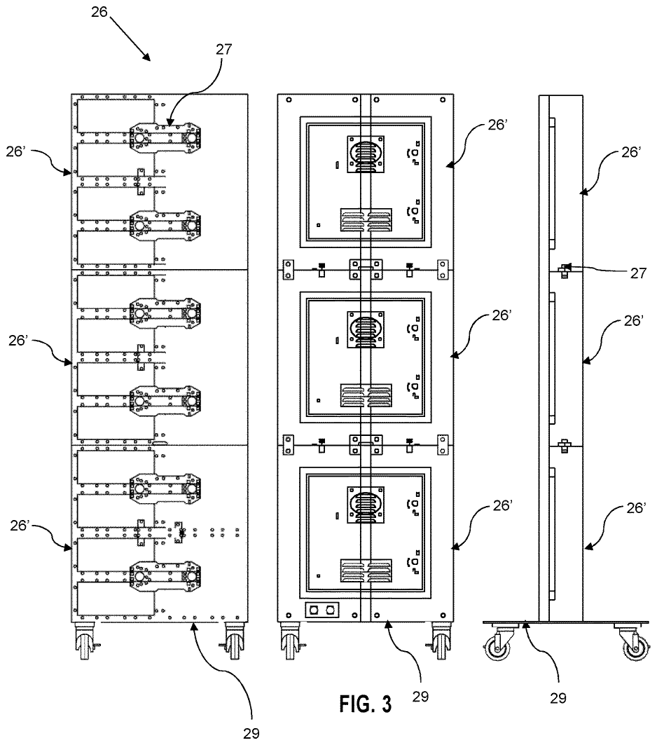

FIG. 3 shows representations of an alternative embodiment of a live feedback display screen used in accordance with the present invention;

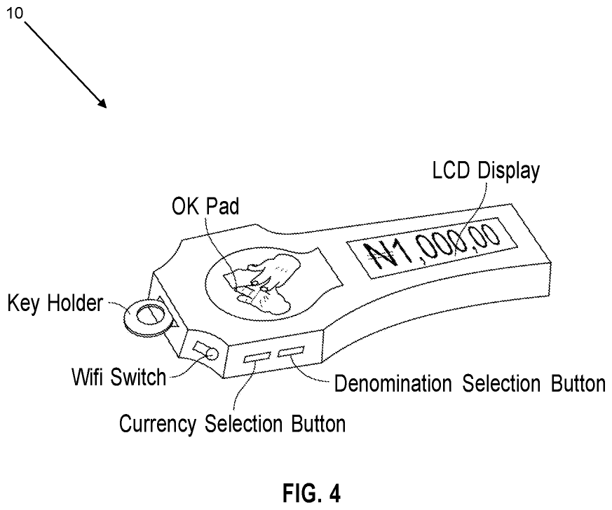

FIG. 4 shows an annotated perspective representation of the device of FIG. 1;

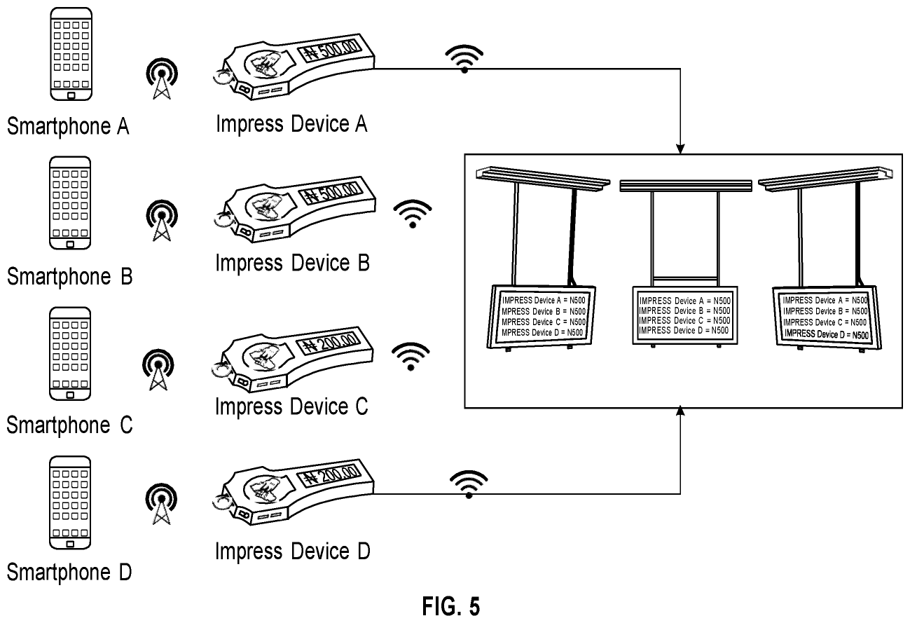

FIG. 5 shows a money-spraying digitalisation system in accordance with the present invention, utilising four devices shown in FIG. 1;

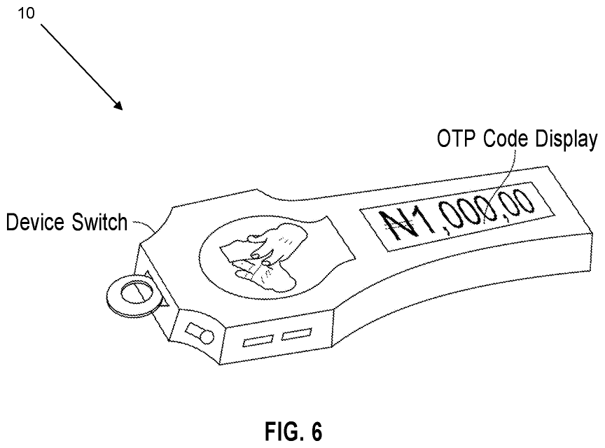

FIG. 6 shows an annotated perspective representation of the device of FIG. 1;

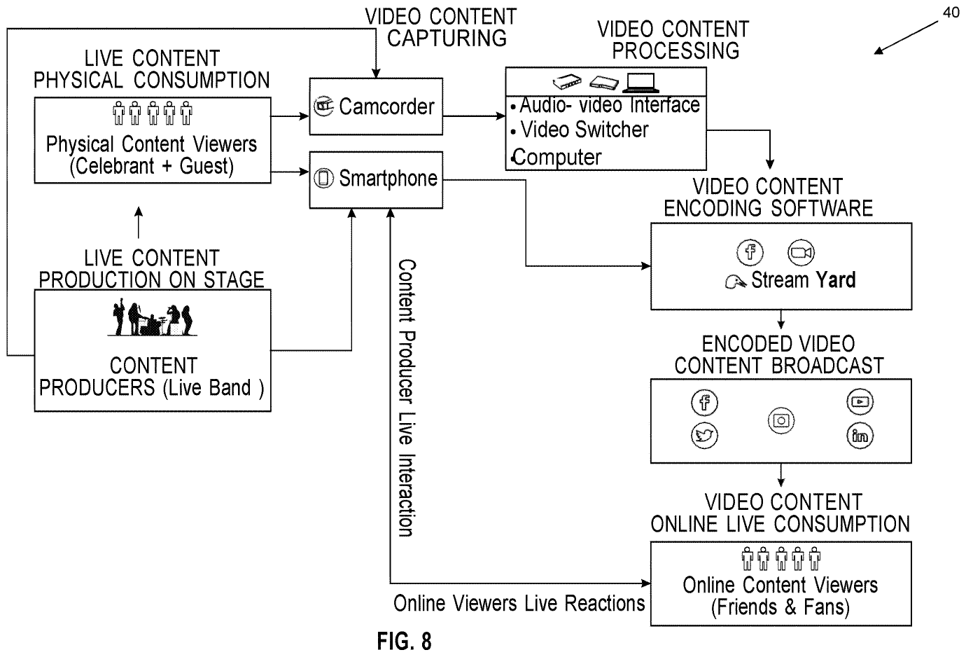

FIG. 8 shows the system architecture for conventional (existing) live video streaming production within the state of the art;

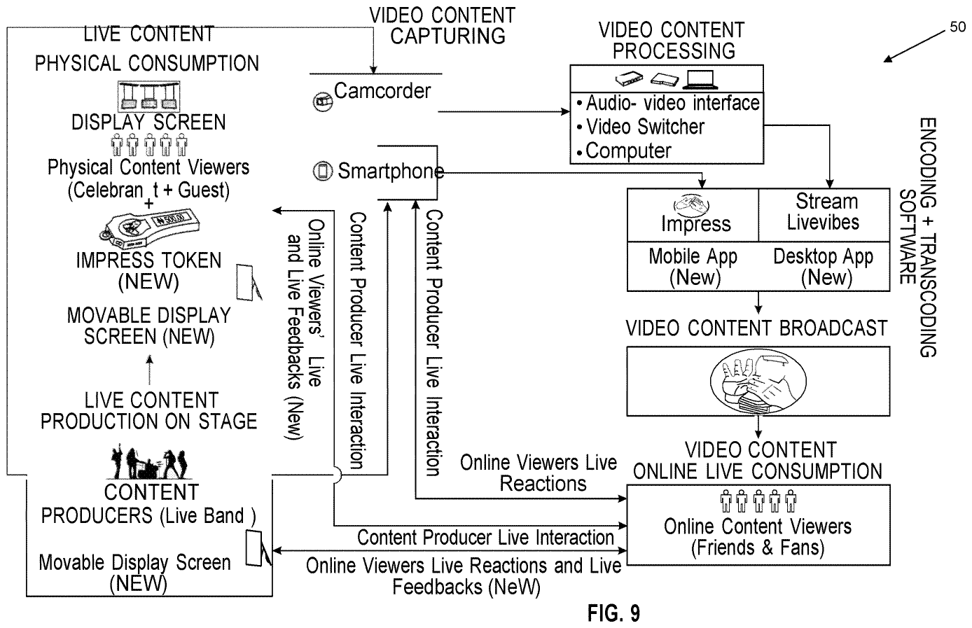

FIG. 9 shows the system architecture for the live video streaming production method in accordance with the present invention; and

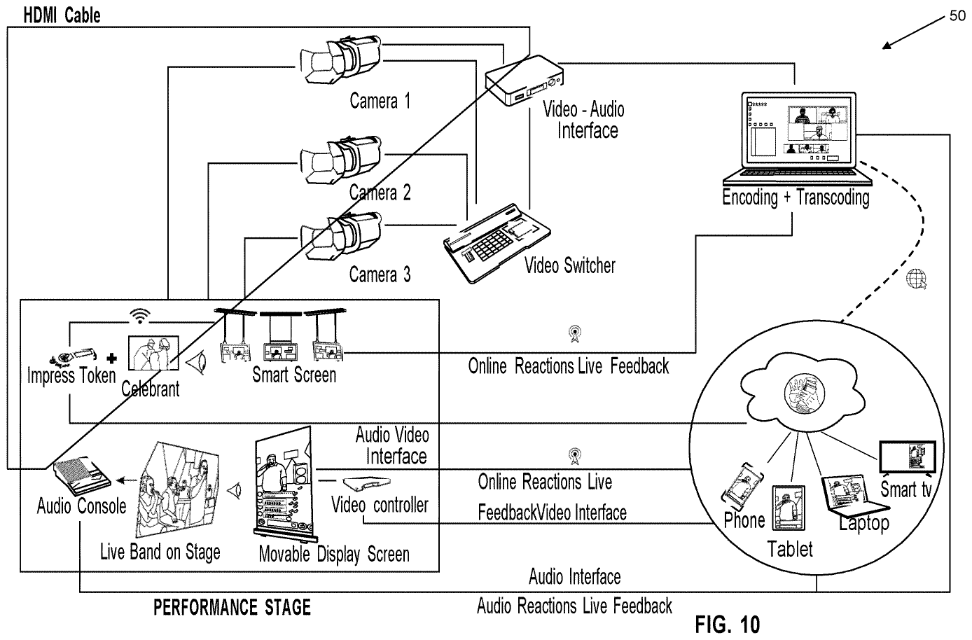

FIG. 10 shows a system for implementing the live video streaming production method in accordance with the present invention.

Referring to FIG. 1, there is indicated a hardware device, indicated globally at 10, and which is colloquially referred to as animpress device in the rest of this document. The Impress device 10 is a wirelessly-communicable, or disconnected, device from which a systematically secure communication and instruction can be wirelessly and remotely selected by a user.

One embodiment of this invention is the use of an ideogram (ideogram: a character symbolizing the idea of a thing without indicating the sounds to say it) to symbolize and drive the act of transferring of money in exchange for goods and services. An indicative indicator region 12 of the device 10 is illustrated, which shows the ideogram of hands spraying money, and this indicator region 12 is formed on a transaction trigger input 14 of the device 10.

Another embodiment of the invention is a distinctive video encoding and transcoding software application, an electronic device combining video live streaming and digital payment technologies to drive a new possibility of using technology to enable users to connect, interact and also make live electronic money transactions with one another through the click of an emoji to animate real transfer of money in exchange of goods and services. A unique computer implemented application for capturing, encoding, transcoding and broadcasting of video content by technically redirecting live feedback from contents and services consumers back to the content producers live during the production thus enabling possibility of innovative and novel features such as live monetization or live payment of contents and services, online stage dance and other live vibes peculiar to live events and entertainment. In other words, there is a computer application implemented which allows for feedback between a content producer and their live and remote viewers.

Another embodiment of this invention is the introduction of feedback production line to produce live feedback in return back to the stage where the production is made via uniquely sized and shaped big movable display screens 16 such in a shape of a poster-dimension banner right in the front of a content producer. The live feedback display screen 16 is innovatively designed and enabled with screen mirroring and casting technology. The display screen 16 is big enough that an entertainer engaged in a live production can briskly glance, read and grasp the content on the display screen from a reasonable distance in order to create easy viewing of feedback reactions from connected consumers during a high quality live video streaming production and then entertainer now has a better avenue of using voice and video chats to interact with any consumers connected to their shows thus, addressing one of the limitations of the existing live video streaming systems.

FIG. 2 shows a movable smart display screen 16 in a shape of poster-dimension banner displaying an artist or similar content producer and comments reactions of fans connected live to his show. The display screen 16 includes a stand 18, with a housing 20 for electronic components on a rear of the flat banner portion 22 of the display screen 16. There are audio output portions 24 positioned on the rear of the flat banner portion 22 to allow for audio feedback to the artist.

An alternative modular live feedback display screen 26, shown in FIG. 3, is uniquely designed to be detachable into a very smaller unit parts for easy transportation in a car boot. It is further designed to be expandable so it can be magnified to any convenient size required to provide the right displays of live feedback for a content producer on a production stage. It is made movable so it can be easily moved around therefore removing the limitation of the display screen 16 of FIG. 2 which has anon-detachable frame but fixed and this makes it stressful and more costly to transport around in a smaller vehicle such as a car.

This modular arrangement is achieved by removing the frame from existing display screens, aligning the plurality of modules 26′ or sub-screens into a superstructure to form a larger screen, and then connecting all of the individual display screens together using fasteners, such as bolt plates, brace plates, or bolts 27. This then yields the modular live feedback display screen of FIG. 3. This effectively yields a spliced display screen formed from abuttably engagable modules 26′, joined together using a modular framework. The modules 26′ can then be wired together to produce a consistent image across all of the individual screens of the superstructure display screen 26, allowing for a much larger image to be produced without making the display screen 26 impossible to transport. FIG. 3 shows a display screen 26 having been formed from three modules 26′, but any combination of numbers or arrangement of screens can be provided to create the desired display screen 26 size.

The modules 26′ may then be connected together via a unifying frame, which may be provided as a modularly assembleable frame. For instance, the frame may comprise short frame sub-structures which can be connected to the desired length of a side of the display screen 26, with specific corner units provided to adapt to corners. The modular frame is preferably connectable to each of the individual modules 26′, again, via fastening elements. It is also possible, as illustrated, to provide a completely frameless display screen 26, with modules 26′ being connected to one another and then mounted to a movable base 29, since the modules 26′ have rigid connector portions which allow for direct connection of adjacent modules 26′ together without a specific frame member to be present. In this way, a poster-like display screen 26 can be produced which does not have the same volumetric requirement as the poster display screen 16 of FIG. 2.

Regardless of whether a modular or static frame is provided, then the frame may take the form of a cabinet. Such a cabinet can be wall mounted using one or more fasteners. This may improve the installation process for the display screen 26.

In this arrangement, no frame is required for transportation, and modules 26′ can be transported in segmented packaging containers, since all of the modules 26′ are of equal dimension. Each module 26′ and frame member of the modularly assembleable frame is configured to be receivable into the boot or trunk of a car or van for ease of transport. It will be apparent, however, that the same principles will apply even for larger modularly assembleable display screens.

Other embodiments of the invention are the conventional video coverage equipment and gadgets such as;
Cameras (phone camera, webcam, HD camcorders etc)—for video content capturing,
Audio Console—for mixing and capturing clearer audio inputs,
Video Switcher—for mixing and switching multiple video camera outputs
Video Controller Processor—for receiving and processing a variety of different video graphics signals into full colour LED displays
Video Audio Interface Box—for connecting the feeds from cameras and audio console into a computer for further fine-tuning
Cables—(HDMI, USB, SDI, VDI)
Computer—where the encoding-software runs for the purpose of fine-tuning the input video feeds for better output and for converting output video file content into a digital file.
Video Splitter—for splitting and feeding the final output video content into more display screens.

The impress device 10 may ultimately run on remote access technology and wireless communication protocols which enables a user to remotely communicate with another of their devices such as a smartphone, tablet, laptop and smart television on which a specially built dual-purpose, payment solution, e-wallet-based live video streaming application can run. The impress device 10 is a Final Instruction Activation Device (FIAD), the device 10 is invented to carry out remote activation of a single and final instruction per time on a money transfer process from an e-wallet account to another account within the same e-wallet services provision driving a Privilege Access Management (PAM) system through the use of the impress device 10. Thus, every impress device 10 needs to be linked to the live video streaming/e-wallet account platform through registering the device barcode scanning or entering its serial numbers in the e-wallet account before a wireless communication can be allowed between the impress device and any of the user's devices housing the live video streaming/e-wallet application as a means of identifying the user. Then, an amount of money or a denomination of a country in a corresponding currency that is pre-set in the e-wallet account of a registered impress device user can be sent to a pre-set receiver's e-wallet account while the final instructional validation of the money transfer from the (user) sender's e-wallet account can also be actuated or activated outside the e-wallet application but through a registered disconnected device 10, to enable the user (sender) to remotely instruct his/her e-wallet account to activate, preferably intermittent, transfer of a pre-set amount of money to a pre-set receiver's via, preferably intermittent, pressing of the transaction trigger input 14 of the device 10. Said transaction trigger input 14 is preferably formed as an OK pad.

FIG. 4 shows a sample of the impress device 10 and some of its features, some of which may be optional:
Transaction Trigger Input/OK Pad 14: The OK Pad activates the exchanging of the amount displayed on the display screen 28 configured to display a transactional value to be authorised by the user during an act of money spraying;
Keyholder 32: This is used to attach the device to a holder or a wristband;
Display Screen 28: Displays a pre-set currency and denomination of money that a holder wishes to transfer. Preferably, this is provided as an LCD display, but could additionally or alternatively be provided as an LED display screen;
Denomination Selection Button/Input 30: This is used to select pre-set denominations of money in correlation with the currency of a country. At the press of the button denominations of corresponding currencies are displayed. This could be pre-programmed to specific common denominations in the relevant country, which may differ between currencies. Alternatively, the denomination selection button 30 may allow the user to select a custom denomination;
Currency Selection Button/Input 34: This button selects currency of a pre-set country a device user wish to transfer. Several different possible currencies could be preloaded into the memory storage element of the device 10, which may be selected between, for instance, Nigerian naira or US dollars;
WiFi® Switch 36: is used for switching on the WiFi® communicator of the impress device 10 to wirelessly mirror the display screen 28 onto an external display, such as a smart screen. It will be apparent that this could relate to a specific communication means, such as WiFi® which expressly connects only to public display screens, whilst not also deactivating other means of communication, such as barcode readers or near-field communication technologies, such as Bluetooth®, which enable communications with other computing devices, such as smartphones.

FIG. 5 shows four different impress devices 10 linked to a wallet supported live video streaming application running on four smartphones linked to different users, nominally users A, B, C, and D.

The four different impress devices 10 of users A, B, C, and D are wirelessly connected with the respective smartphones of users A, B, C, and D with each impress device 10 configured to exclusively work with each user's smartphone by a pairing function, so that one person's impress device 10 does not work for another's smartphone. This is to ensure a level of security in using the new device 10. FIG. 5 further shows how the impress devices 10 are wirelessly connected to public display screens at a live event to project ostentatious feelings for every user. One of the users'powers to control their privacy over the impress device is that any user can decide not to project into the public display screen by simply switching off the WiFi® on the impress device 10 by toggling the WiFi® switch 36. It will be apparent to the skilled reader that, whilst a WiFi® switch 36 is provided and discussed, alternative wireless communications protocols are also feasible, such as near-field communication, and this is intended within the scope of the present invention.

In order to add an extra layer of security, the impress device could also serve a dual-use for user's identity authentication mechanism, here illustrated as a device switch 38 which allows the user to generate a One-Time Passcode for said users e-wallet account login security.

FIG. 6 shows the users identity authentication features of the impress device 10. The one-time passcode may be displayed on the same display screen 28 as illustrated the currency and denomination to be transferred during a money-spraying event.

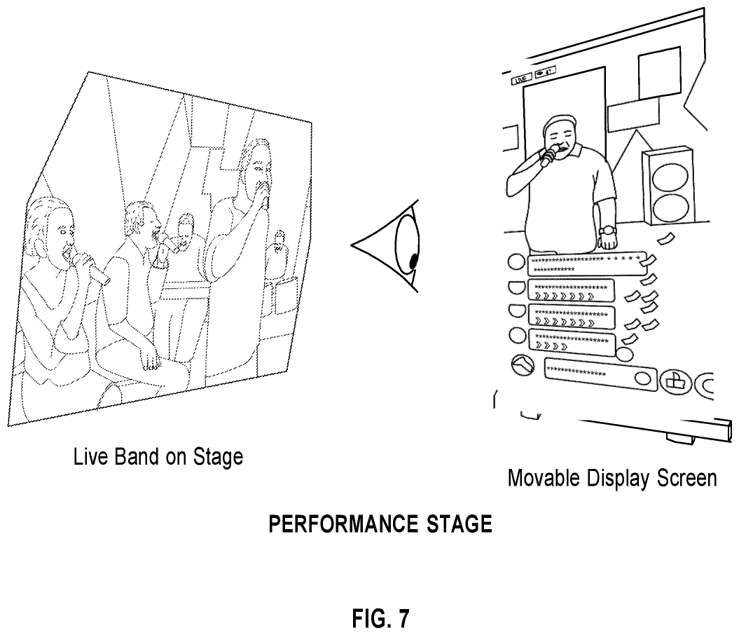

It is clear like never before that live video streaming production needs a different set up with new features and new interactive ways where content producers can interact more and easily interface more with any fans and friends connected to them live online thus addressing a limitation of the existing live video streaming inventions in creating live online-interactions between an artist right on-stage and their connected online fans, thus, in this improved video production method, larger views of all connected online fans and their reactions per time during any live performance of a performing artist are projected back to the view of the performing artist through a strategically positioned creative display screen on the performance stage as shown in FIG. 7, to enable the performing artist to follow up on the quality of production and also interact readily with connected fans while right there on the stage. This feature of this new invention is therefore creating a far better possibility to drive live online-interactions during any live video streaming production and also creating industrial capacity to promote the use of creative digital screen which could come in any sizes and shapes for the purpose of creating best feedback viewing experience to an engaged content producer.

FIG. 7 shows a live feedback screen 16 set-up for an artist during a live video streaming to aid his live interactions with any of his fans connected online. The artist and/or artists are live on stage, but are able to visualise their own performance via the feedback screen 16, whilst live feedback updates are displayed on the feedback screen 16 as an overlay to the live images.

The application of the impress device 10 and the new method for creating a consistent live feedback to content producer during live video streaming production will be fully understood from its diagram description, in particular from Figures to 10.

FIG. 8 shows the system architecture 40 for conventional (existing) live video streaming production set up with no feedback connection back to the content producers. The live video and audio can be recorded by physically-present individuals, such as celebrants or guests on camcorders and smartphones, passed through appropriate video content processing, and online live consumption can be provided to remote users this way. This is traditional video streaming. Remote users have no means of providing feedback other than via their smartphones, for example, which has no mechanism for being directed back to the content provider in real-time.

FIG. 9 shows the system 50 for the new live video streaming production method showing the feedback connections back to the content producers (live performing artist and event celebrant).

Live content from the stage is produced by the content producer. At the venue there will be the public display screens which can be seen by the local guests and celebrant, as well as potentially also the content producers. There is also the display screen 16 which displays the feedback directly to the content producers. Impress devices 10 are also present and provided to the guests at the location to allow for easy money-spraying to be achieved.

Recording of the event can be performed by a camcorder or smartphone which can then be processed and streamed via the dedicated software, provided as a computer application for a mobile or desktop computer. The video content produced is then broadcast so as to be viewable by online content viewers, who can provide live feedback reactions in the form of comments, emojis, money spraying, and other forms of feedback.

In the present invention, the live feedback can be transmitted to the display screen 16 to the content producers. It can be provided to the public display screens and/or any display screens 26 directed at the guests. It can also be provided to user's smartphones.

FIG. 10 shows a high quality Multi-Camera Live Video Streaming Production Set-Up of the present system for enabling live video streaming providing magnified live feedback with a newly introduced live feedback equipment set-up to aid live and online-interactions between content producer and consumers while the production is going on. A plurality of cameras can be provided to record the live content producers on stage, which can be processed via a video-audio interface and/or video switcher. This video stream is then encoded and transcoded for broadcast to other devices, such as a smartphone, tablet, laptop, and/or smart television. The online reactions can be fed back through the feedback video interface and/or feedback audio interface. This can then be directed to the display screen 16 which is presented to the content producer.

It should be understood that the features and process described herein are not all-inclusive. Many additional features and modifications such as in cables' selections and connections will be apparent to a person having ordinary skill in the art in view of the background, detailed descriptions, and claims of this invention. Moreover, it should be noted that the language used in the detailed description has been selected for instructional purposes, and should not be construed as limiting the scope of the inventive subject matter.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A device for digitalization of an act of money spraying to drive live monetization and live payments for live and online entertainment and event services and contents, comprising:
a transaction trigger input;
a display screen configured to display a transactional value to be authorised by the user during an act of money spraying;
a memory storage element for storing at least a currency type and currency amount which contribute to the said transactional value;
a wireless communications means communicable with third-party devices;
a user identification authorisation mechanism configured to generate a one-time passcode for an e-wallet associated with the device; and
a processor configured to validate a transfer of the said transactional value from the e-wallet to a third-party upon activation of the transaction trigger input.

2. The device of claim 1, further comprising at least one of a currency selection button and a denomination selection button for selecting pre-loaded data of currencies and/or denominations stored in the memory storage element.

3. The device of claim 1, further comprising a switch for selectable activation or deactivation of the wireless communications means.

4. The device of claim 1, wherein the memory storage element comprises stored instruction having any or all of the following functions;
selecting and displaying currency denominations;
displaying the one-time passcode;
remotely accessing an e-wallet in a digital payment-solution-enabled-live-video-streaming application running on a separate and disconnected device;
driving remote validation and activation of a final and concluding instruction of transferring a pre-set amount of money from the accessed e-wallet; and/or driving a user identification-authentication protocol to create a login security for a user.

5. The device of claim 1, further comprising a remote instruction-activation mechanism which is configured to allow the device to remotely and wirelessly locate and connect to another device on which a digital payment-solution-enabled-live-video-streaming application is running, and further configured to remotely validate and activate a final and concluding instruction of money transfer from the e-wallet in the digital payment-solution-enabled-live-video-streaming application running on the located and connected device.

6. The device of claim 1, wherein the device is configured to turn on either at the press of the transaction trigger input for the first time of use, or when a wireless connection of the device on which an e-wallet supported live video streaming application is installed is switched on.

7. The device of claim 1, wherein the device is configured to turn off automatically when it is left unused or inoperative for a predetermined duration.

8. The device of claim 1, wherein the processor is configured to activate random transfer (spraying) of money via random pressing of the transaction trigger input.

9. The device of claim 1, wherein the processor is further configured to activate money transfer only if authorisation data on the display screen is the same as authorisation data in a user's e-wallets account.

10. The device of claim 1, wherein the display screen is configured to selectably switch between displaying a currency and/or denomination activatable by the transaction trigger input and the one-time passcode, depending on a mode of use.

11. The device of claim 1, wherein the wireless communications means comprises a WiFi® communications means.

12. The device of claim 1, wherein the wireless communication means comprises a communication protocol for communicating with an external display screen for the purpose of enabling the user to create an ostentatious vibe for public viewing.

13. (canceled)

14. A method of live video streaming providing magnified live feedback, the method comprising the steps of:
a] channelling live video and audio files through an e-wallet-supported live video streaming application;
b] broadcasting the live video and audio captured as a live media stream to online consumers; and
c] duplicating the live media stream enriched with live reactions/interactions from live and/or online consumers and sending it back to an on-stage content producer through a display screen;
wherein the live video streaming application is programmed to process the live video and audio captured via an encoding and transcoding software program to create and convert animation of an act of money spraying to real money transfer within e-wallets operated within the tailored e-wallet supported live video streaming application.

15. The method of claim 14, during step c], the display screen is a modular display screen comprising a plurality of individual modules which are interconnected.

16. The method of claim 14 wherein the live reactions/interactions comprise audio reactions from live and/or online consumers.

17. The method of claim 14, wherein during step c], all money transfer (spraying reactions) from the content consumers are fed back live to contents producer while on stage.

18-21. (canceled)

22. A modular display screen for use with a system, for live video streaming providing magnified live feedback, the display screen comprising a plurality of individual modules which are interconnected to form a larger unified display screen, wherein each of the individual modules includes a rigid connection region via which the display screen can be assemble in a frameless or framed manner.

23. A modular display screen as claimed in claim 22, wherein the display screen comprises a modularly assembleable frame around the plurality of individual modules.

24. A modular display screen as claimed in claim 22 23, wherein the modularly assembleable frame comprises a plurality of interconnectable frame members.

25. A modular display screen as claimed in claim 22, wherein the plurality of individual modules are interconnected via one or more fastening elements.
